(19) United States
(12) Patent Application Publication
(10) Pub. No.: US 2008/0018897 A1
(43) Pub. Date: Jan. 24, 2008

(54) Methods and apparatuses for assessing overlay error on workpieces

(75) Inventor: Michael Littau, Bend, OR (US)

Correspondence Address: PERKINS COIE LLP;PATENT-SEA, P.O. BOX 1247, SEATTLE, WA, 98111-1247, US

(73) Assignee: Nanometrics Incorporated, Milpitas, CA (US)

(21) Appl. No.: 11/650,022

(22) Filed: Jan. 5, 2007

Related U.S. Application Data
(60) Provisional application No. 60/832,319, filed on Jul. 20, 2006.

(51) Int. Cl. G01B 11/00

(52) U.S. Cl. 356/401

(57) ABSTRACT

Methods and apparatuses for evaluating overlay error on workpieces are disclosed herein. In one embodiment, a method includes generating a beam having a wavelength, and irradiating a first alignment structure on a first layer of a workpiece and a second alignment structure on a second layer of the workpiece by passing the beam through an object lens assembly that focuses the beam to a focus area at a focal plane. The beam is simultaneously focused through angles of incidence having (a) altitude angles of 0° to at least 150 and (b) azimuth angles of 0° to at least 900. The method further includes detecting an actual radiation distribution corresponding to radiation scattered from the first and second alignment structures, and estimating an offset parameter of the first and second alignment structures based on the detected radiation distribution.

### CROSS-REFERENCE TO RELATED APPLICATION

This application claims the benefit of U.S. Provisional Patent Application No. 60/832,319, filed Jul. 20, 2006, which is incorporated by reference herein.

### TECHNICAL FIELD

The present disclosure is related to methods and apparatuses for evaluating overlay error on workpieces, such as semiconductor wafers.

### BACKGROUND

Semiconductor devices and other microelectronic devices are typically manufactured on a wafer having a large number of individual dies (e.g., chips). Each wafer undergoes several different procedures to construct the switches, capacitors, conductive interconnects, and other components of a device. For example, a wafer can be processed using lithography, implanting, etching, deposition, planarization, annealing, and other procedures that are repeated on successive layers to construct a high density of features. One aspect of manufacturing microelectronic devices is evaluating the wafers to ensure that the microstructures are within the desired specifications.

Overlay metrology is used to determine the alignment of different layers on a wafer. Proper alignment of each layer is required to ensure the operability of the devices formed on the wafer. Misregistration between layers is referred to as overlay error. Overlay metrology tools measure overlay error and can feed the information into a closed loop system to correct the error. Accurate and quick measurement of layer alignment is important for maintaining a high level of manufacturing efficiency.

Conventional overlay metrology uses targets that are printed onto different layers of a wafer during fabrication. For example, one commonly known target has a “box-in-box” configuration. The overlay metrology tools determine overlay error by measuring the relative displacement of the target on different layers. Specifically, the tools image the target at high magnification, digitize the images, and process the image data using various known image analysis algorithms to quantify the overlay error.

One approach to improve the precision of overlay metrology includes analyzing overlay error via scatterometry. One drawback of presently known methods of scatterometric overlay metrology is that the individual targets must have two perpendicular portions on each layer so that the misregistration in both the X and Y directions can be measured. Targets with two perpendicular portions have relatively large footprints and occupy significant space on the wafer. As a result, these targets can be formed on only a limited number of locations on the wafer that have sufficient space.

### BRIEF DESCRIPTION OF THE DRAWINGS

FIG. 1 is a schematic illustration of a scatterometer in accordance with one embodiment of the invention.

FIG. 2A is a schematic view illustrating an optical system for use in a scatterometer in accordance with an embodiment of the invention.

FIG. 2B is a schematic view of a cube-type polarizing beam splitter for use in a scatterometer in accordance with an embodiment of the invention.

FIG. 2C is a schematic view of a CMOS imager for use in a scatterometer in accordance with an embodiment of the invention.

FIG. 3 illustrates one embodiment of the convergent beam formed by the optical system illustrated in FIG. 2A.

FIG. 4 is a schematic diagram illustrating a convergent beam in accordance with one embodiment of the invention.

FIG. 5 is a schematic illustration of an example of a radiation distribution image detected by the scatterometer.

FIGS. 6-11 schematically illustrate several examples of intensity distributions of particular diametric slices resulting from misaligned alignment structures.

FIG. 6 schematically illustrates the intensity distribution of a diametric slice of the image illustrated in FIG. 5 taken at the angle Φ=0.

FIG. 7 schematically illustrates the intensity distribution of a diametric slice of the image illustrated in FIG. 5 taken at the angle Φ=45.

FIG. 8 schematically illustrates the intensity distribution of a diametric slice of the image illustrated in FIG. 5 taken at the angle Φ=90.

FIG. 9 schematically illustrates the intensity distribution of a diametric slice of another image taken at the angle Φ=0.

FIG. 10 schematically illustrates the intensity distribution of a diametric slice of the other image taken at the angle Φ=90.

FIG. 11 schematically illustrates the intensity distribution of a diametric slice of the other image taken at the angle Φ=45.

FIG. 12 illustrates one embodiment for ascertaining overlay offset parameters in accordance with the invention.

### DETAILED DESCRIPTION

### A. Overview

The present disclosure is directed toward methods and apparatuses for evaluating overlay error on semiconductor workpieces and other types of microelectronic substrates or wafers. The term “workpiece” is defined as any substrate or wafer either by itself or in combination with additional materials that have been implanted in or otherwise deposited over the substrate. For example, semiconductor workpieces can include substrates upon which and/or in which microelectronic circuits or components, epitaxial structures, data storage elements or layers, and/or vias or conductive lines are or can be fabricated. Semiconductor workpieces can also include patterned or unpatterned wafers.

One aspect of the invention is directed toward methods of assessing overlay error on workpieces. In one embodiment, a method includes generating a beam having a wavelength, and irradiating a first alignment structure on a first layer of a workpiece and a second alignment structure on a second layer of the workpiece by passing the beam through an object lens assembly that focuses the beam to a focus area at a focal plane. The beam is simultaneously focused through angles of incidence having (a) altitude angles of 0° to at least 15° and (b) azimuth angles of 0° to at least 90°. The method further includes detecting an actual radiation distribution corresponding to radiation scattered from the first and second alignment structures, and estimating an offset parameter of the first and second alignment structures based on the detected radiation distribution.

In another embodiment, a method includes providing a workpiece having a first doubly periodic alignment structure on a first layer of the workpiece and a second doubly periodic alignment structure on a second layer of the workpiece, generating a beam of radiation having a wavelength, and passing the beam through a lens that focuses the beam to a focus area at a focal plane. The focus area has a dimension not greater than 40 μm, and the beam is focused through a range of angles of incidence having simultaneously (a) altitude angles of 0° to at least 15° and (b) azimuth angles of 0° to at least 90°. The method further includes detecting a radiation distribution of radiation returned from the first and second alignment structures, and determining an offset angle of the first and second alignment structures based on the detected radiation distribution.

In another embodiment, a method includes providing a workpiece having a first alignment structure on a first layer of the workpiece and a second alignment structure on a second layer of the workpiece, generating a beam of radiation having a wavelength, and irradiating the first and second alignment structures by passing the beam through a lens that focuses the beam to a focus area at a focal plane. The beam is focused through a range of angles of incidence having simultaneously (a) altitude angles of 0° to at least 15° and (b) azimuth angles of 0° to at least 90°. The method further includes sensing a radiation distribution of radiation returned from the first and second alignment structures, determining an intensity distribution along a plurality of sections of the sensed radiation distribution, identifying a particular section with the greatest symmetry, and calculating an offset angle of the first and second alignment structures based on a position of the section with the greatest symmetry.

Another aspect of the invention is directed to scatterometers for evaluating overlay error on workpieces. The workpieces include a first alignment target on a first layer and a second alignment target on a second layer. In one embodiment, a scatterometer includes an irradiation source for producing a beam of radiation along a path, an optic member aligned with the path of the beam, and an object lens assembly aligned with the path of the beam and positioned between the optic member and a workpiece site. The optic member is configured to condition the beam. The object lens assembly is configured to (a) receive the conditioned beam, (b) simultaneously focus the conditioned beam through a plurality of altitude angles to a spot at an object focal plane, (c) receive return radiation in the wavelength scattered from the workpiece, and (d) present a radiation distribution of the return radiation at a second focal plane. The scatterometer further includes a detector positioned to receive the radiation distribution and a controller operably coupled to the detector. The detector is configured to produce a representation of the radiation distribution. The controller has a computer-readable medium containing instructions to calculate an offset angle between the first and second alignment targets of the workpiece based on the representation of the radiation distribution.

In another embodiment, a scatterometer includes a radiation source configured to produce a beam of radiation having a wavelength, and an optical system having a first optics assembly and an object lens assembly. The first optics assembly is configured to condition the beam of radiation such that beam is diffuse and randomized. The object lens assembly is configured to (a) focus the beam at an area of an object focal plane and (b) present a radiation distribution of return radiation scattered from an alignment structure in a second focal plane. The scatterometer further includes a detector positioned to receive the radiation distribution and a controller operably coupled to the radiation source and the detector. The detector is configured to produce a representation of the radiation distribution. The controller includes a computer-readable medium containing instructions to perform a method comprising (a) irradiating the first and second alignment structures, (b) detecting the radiation distribution, and (c) estimating an offset parameter of the first and second alignment structures based on the detected radiation distribution.

Many specific details of certain embodiments of the invention are set forth in the following description to provide a thorough understanding and enabling description of these embodiments. A person skilled in the art, however, will understand that the invention may be practiced without several of these details or additional details can be added to the invention. Well-known structures and functions have not been shown or described in detail to avoid unnecessarily obscuring the description of the embodiments of the invention. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of items in the list.

### B. Embodiments of Scatterometers and Methods for Evaluating Overlay Error on Workpieces

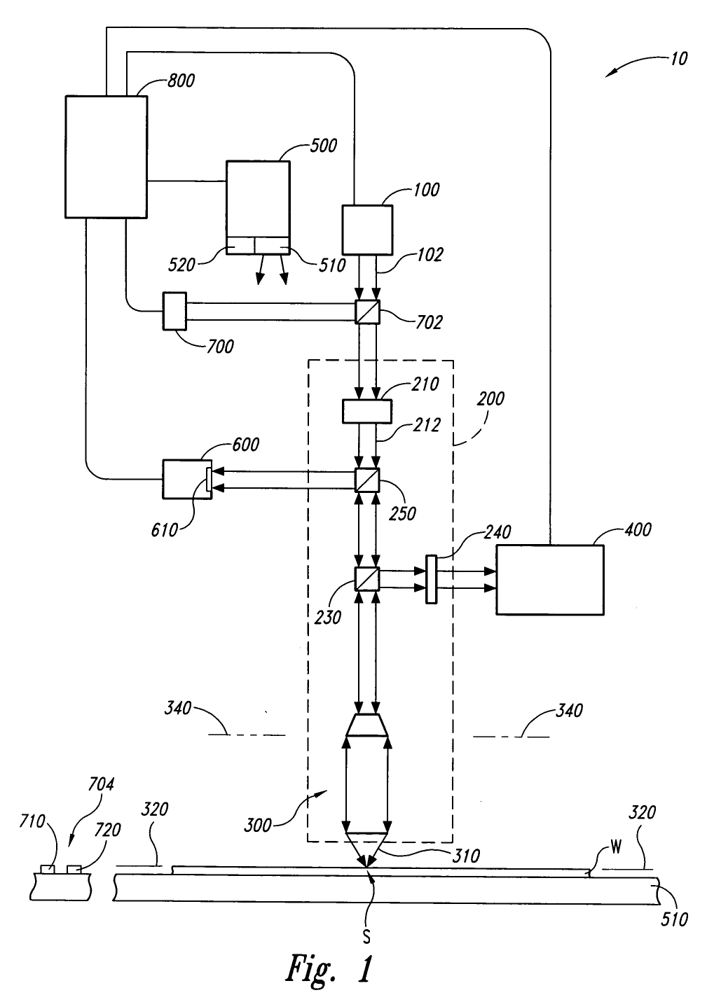

FIG. 1 is a schematic illustration of a scatterometer 10 in accordance with one embodiment of the invention. In this embodiment, the scatterometer 10 includes an irradiation source 100 that generates a beam 102 at a desired wavelength. The irradiation source 100 can be a laser system and/or lamp capable of producing (a) a beam 102 at a single wavelength, (b) a plurality of beams at different wavelengths, or (c) any other output having a single wavelength or a plurality of wavelengths. In many applications directed toward assessing overlay alignment structures on semiconductor workpieces, the irradiation source 100 is a laser that produces a beam having a wavelength of approximately 632.8 nm. In other embodiments, the beam may have a different wavelength. For example, the wavelength can be about 266 nm-475 nm (e.g., 375 nm-475 nm) or in some specific examples about 405 nm or 457 nm. It will be appreciated that the irradiation source 100 can produce additional wavelengths having shorter or longer wavelengths in the UV spectrum, visible spectrum, and/or other suitable spectrum. The irradiation source 100 can further include a fiber optic cable to transmit the beam 102 through a portion of the apparatus.

The scatterometer 10 further includes an optical system 200 between the irradiation source 100 and a workpiece W. In one embodiment, the optical system 200 includes a first optics assembly 210 that conditions the beam 102 to form a conditioned beam 212. The first optics assembly 210 can also include (a) a beam diffuser/randomizer that diffuses and randomizes the radiation to reduce or eliminate the coherence of the beam 102, and (b) a beam element that shapes the beam 102 to have a desired cross-sectional dimension, shape, and/or convergence-divergence. The beam element, for example, can shape the beam 212 to have a circular, rectilinear, or other suitable cross-sectional shape for presentation to additional optic elements downstream from the first optics assembly 210.

The optical system 200 can further include an object lens assembly 300 that focuses the conditioned beam 212 for presentation to the workpiece W and receives radiation reflected from the workpiece W. The object lens assembly 300 is configured to receive the conditioned beam 212 and form a convergent beam 310 focused at a discrete focus area S on a desired focal plane, such as an object focal plane 320. The convergent beam 310 can be a conical shape when the conditioned beam 212 has a circular cross-section, but in other embodiments the convergent beam 310 can have other shapes. For example, when the conditioned beam 212 has a rectilinear cross-sectional area, the convergent beam 310 has a pyramidal shape. As explained in more detail below with reference to Section C, the convergent beam 310 can have a range of incidence angles having altitude angles of 0° to greater than approximately 70° and azimuth angles of 0° to greater than 90° (e.g., 0-360°). The altitude angle is the angle between an incident ray and a reference vector normal to the object focal plane 320, and the azimuth angle is the angle between an incident plane and a reference vector in a plane parallel to the object focal plane 320. The large range of incidence angles generates a large number of unique data points that enable accurate evaluations of several parameters of the workpiece W including overlay alignment.

The focus area at the object focal plane 320 preferably has a size and shape suitable for evaluating overlay alignment structures (e.g., targets) on different layers of the workpiece W. For example, in one embodiment, the size of the focal area is less than or equal to the size of the alignment structures so that the radiation does not reflect from features outside of the particular alignment structures. In many applications, therefore, the object lens assembly 300 is configured to produce a spot size generally less than 40 μm (e.g., less than 30 μm). The scatterometer 10 can have larger focus areas in other embodiments directed to assessing larger alignment structures. In additional embodiments, the focal area can be greater than the size of the alignment structures.

The object lens assembly 300 is further configured to collect the scattered radiation reflecting or otherwise returning from the workpiece W and present the scattered radiation on a second focal plane 340. The object lens assembly 300, more particularly, presents the scattered radiation in a manner that provides a radiation distribution of the scattered radiation at the second focal plane 340. In one embodiment, the object lens assembly 300 directs the scattered radiation coming at particular angles from the object focal plane 320 to corresponding points on the second focal plane 340. Additional aspects of specific embodiments of the object lens assembly 300 are further described below with reference to Section C.

The optical system 200 can further include a beam splitter 230 through which the conditioned beam 212 can pass to the object lens assembly 300 and from which a portion of the return beam propagating away from the second focal plane 340 is split and redirected. The optical system 200 can optionally include a second optics assembly 240 that receives the split portion of the return beam from the beam splitter 230. The second optics assembly 240 is configured to prepare the return beam for imaging by an imaging device. Additional aspects of specific embodiments of the second optics assembly 240 are described below with reference to Section C.

The scatterometer 10 further includes a detector 400 positioned to receive the radiation distribution propagating back from the second focal plane 340. The detector 400 can be a CCD array, CMOS imager, other suitable cameras, or other suitable energy sensors for accurately measuring the radiation distribution. The detector 400 is further configured to provide or otherwise generate a representation of the radiation distribution. For example, the representation of the radiation distribution can be data stored in a database, an image suitable for representation on a display, or other suitable characterizations of the radiation distribution. Several embodiments of the detector 400 are described below in greater detail with reference to Section D.

The scatterometer 10 can further include a navigation system 500 and an auto-focus system 600. The navigation system 500 can include a light source 510 that illuminates a portion of the workpiece W and optics 520 that view the workpiece W. The navigation system 500 can have a low magnification capability for locating a general region of the workpiece (e.g., the region having the overlay alignment structures), and a high magnification capability for precisely identifying the location of the alignment structures. Several embodiments of the navigation system can use the irradiation source 100 and components of the optical system 200. The navigation system 500 provides information to move the object lens assembly 300 and/or a workpiece site 510 to accurately position the focus area of the object lens assembly 300 at the desired alignment structures on the workpiece W. In other embodiments, the scatterometer 10 may not include the navigation system 500.

The auto-focus system 600 can include a focus array 610, and the optical system 200 can include an optional beam splitter 250 that directs radiation returning from the workpiece W to the focus array 610. The auto-focus system 600 is operatively coupled to the object lens assembly 300 and/or the workpiece site 510 to accurately position the alignment structures on the workpiece W at the object focal plane 320 of the object lens assembly 300 or another plane. The navigation system 500 and the auto-focus system 600 enable the scatterometer 10 to evaluate extremely small alignment structures on the workpiece W. In other embodiments, the scatterometer 10 may not include the auto-focus system 600.

The scatterometer 10 can further include a calibration system for monitoring the intensity of the beam 102 and maintaining the accuracy of the other components. The calibration system (a) monitors the intensity, phase, wavelength, or other property of the beam 102 in real time, (b) provides an accurate reference reflectance for the detector 400 to ensure the accuracy of the scatterometer 10, and/or (c) provides angular calibration of the system. In one embodiment, the calibration system includes a detector 700 and a beam splitter 702 that directs a portion of the initial beam 102 to the detector 700. The detector 700 monitors changes in the intensity of the beam 102 in real time to continuously maintain the accuracy of the measured radiation distribution. The detector 700 can also or alternatively measure phase changes or a differential intensity. The calibration system, for example, can use the polarity of the return radiation to calibrate the system.

The calibration system may further include a calibration unit 704 having one or more calibration members for calibrating the detector 400. In one embodiment, the calibration unit 704 includes a first calibration member 710 having a first reflectance of the wavelength of the beam and a second calibration member 720 having a second reflectance of the wavelength of the beam. The first calibration member 710 can have a very high reflectance, and the second calibration member 720 can have a very low reflectance to provide two data points for calibrating the detector 400. In other embodiments, the second calibration member 720 can be eliminated and the second reflectance can be measured from free space.

The scatterometer 10 further includes a computer 800 operatively coupled to several of the components. In one embodiment, the computer 800 is coupled to the irradiation source 100, the detector 400, the navigation system 500, the auto-focus system 600, and the reference detector 700. The computer 800 is programmed to operate the irradiation source 100 to produce at least a first beam having a first wavelength and, in several applications, a second beam having a second wavelength, as described above. The computer 800 can also control the irradiation source 100 to control the output intensity of the beam. The computer 800 further includes modules to operate the navigation system 500 and the auto-focus system 600 to accurately position the focus area of the convergent beam 310 at a desired location on the workpiece W and in precise focus.

The computer 800 further includes a computer-operable medium for evaluating the overlay offset of different layers on the workpiece W. Specifically, the computer 800 can determine the offset angle based on the measured radiation distribution. The offset angle can then be used to calculate the other overlay offset parameters (e.g., offset distance and offset direction). In several embodiments, the computer 800 can include a database having a plurality of simulated radiation distributions corresponding to known parameters of overlay error. The computer 800 can include computer-operable media to process the measured radiation distribution in conjunction with the database of simulated radiation distributions in a manner that selects the simulated radiation distribution that best fits the measured radiation distribution at the calculated offset angle. Based on the selected simulated radiation distribution, the computer stores and/or presents the overlay offset parameters corresponding to those of the simulated radiation distribution, or an extrapolation or interpolation of such parameters. Several aspects of the computer 800 and methods for processing the measured radiation distribution are set forth below in greater detail with reference to Section E.

### C. Embodiments of Optics and Object Lens Assemblies

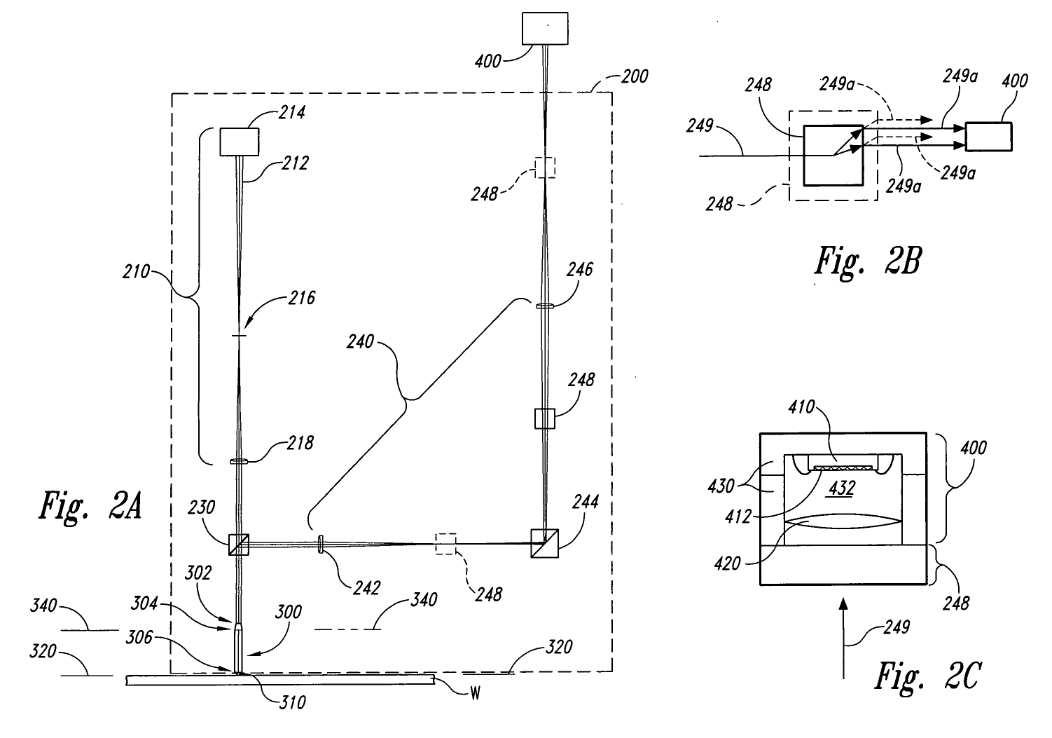

FIG. 2A is a schematic diagram illustrating one specific embodiment of the optical system 200 in accordance with the invention. In this embodiment, the first optics assembly 210 includes a beam conditioner 214, a field stop 216, and an illumination lens 218. The beam conditioner 214 is configured to produce a conditioned beam 212 having diffused and randomized radiation. The beam conditioner 214 can be a fiber optic line that transmits the beam from the irradiation source 100 (FIG. 1) and an actuator that moves the fiber optic line to randomize the laser beam. The actuator can move the beam conditioner 214 in such a way that it does not repeat its movement over successive iterations to effectively randomize the radiation. The field stop 216 is positioned in the first focal plane of the illumination lens 218, and the field stop 216 can have an aperture in a desired shape to influence the spot size and spot shape in conjunction with the illumination lens 218. In general, the illumination lens 218 collimates the radiation for presentation to the object lens assembly 300.

The object lens assembly 300 illustrated in FIG. 2A receives the conditioned beam 212 from the first optics assembly 210. The object lens assembly 300 can be achromatic to accommodate a plurality of beams at different wavelengths, or it can have a plurality of individual assemblies of lenses that are each optimized for a specific wavelength. Such individual lens assemblies can be mounted on a turret that rotates each lens assembly in the path of the beam according to the wavelength of the particular beam, or such lenses may be mounted in separate, fixed positions that correspond to the incident beam paths of the respective wavelengths. In either case, the object lens assembly 300 can be useful for applications that use a single wavelength or different wavelengths of radiation to obtain information regarding the radiation returning from the workpiece W.

The object lens assembly 300 can also include reflective lenses that are useful for laser beams in the UV spectrum. Certain types of glass may filter UV radiation. As such, when the beam has a short wavelength in the UV spectrum, the object lens assembly 300 and other optic members can be formed from reflective materials that reflect the UV radiation. In another embodiment, the first optics assembly 210 or the object lens assembly 300 may have a polarizing lens that polarizes the radiation for the convergent beam 310.

The illustrated object lens assembly 300 includes a divergent lens 302, a first convergent lens 304, and a second convergent lens 306. The first convergent lens 304 can have a first maximum convergence angle, and the second convergent lens 306 can have a second maximum convergence angle. In operation, the object lens assembly 300 (a) focuses the conditioned beam 212 to form the convergent beam 310, and (b) presents the return radiation from the workpiece W on the second focal plane 340. The location of the second focal plane 340 depends upon the particular configurations of the lenses 302, 304, and 306. For purposes of illustration, the second focal plane 340 is shown as coinciding with the location of the first convergent lens 304.

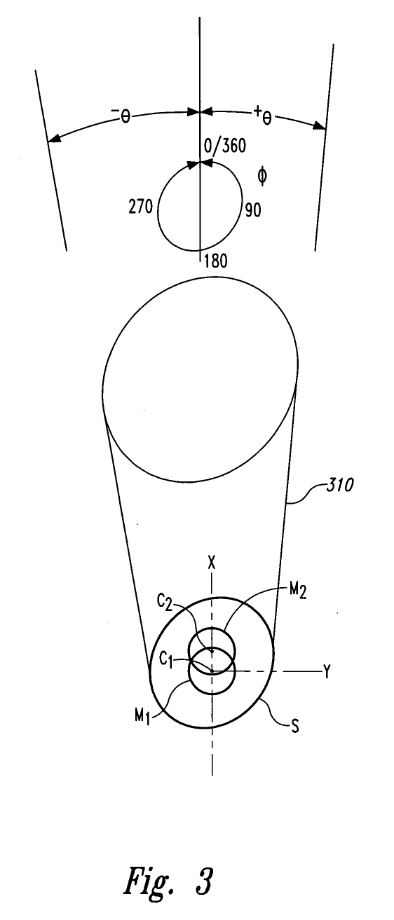

FIG. 3 illustrates one embodiment of the convergent beam 310 formed by an embodiment of the object lens assembly 300. The convergent beam 310 illustrated in FIG. 3 has a frusto-conical configuration that results in a focus area S. The illustrated focus area S is circular and greater than the area of the alignment structures under evaluation. In other embodiments, the focus area S may not necessarily be circular and may not be greater than the area of the alignment structures under evaluation. The illustrated workpiece W includes a first doubly periodic alignment structure M₁ (shown schematically) on a first layer of the workpiece W and a second doubly periodic alignment structure M₂ (shown schematically) on a second layer of the workpiece W. In the illustrated workpiece W, the first and second layers are misaligned such that the first alignment structure M₁ has a first center C₁ and the second alignment structure M₂ has a second center C₂ offset from the first center C₁ in the X direction but not the Y direction.

The convergent beam 310 simultaneously illuminates the first and second alignment structures M₁ and M₂ through a wide range of incidence angles having large ranges of altitude angles Θ and azimuth angles Φ. Each incidence angle has an altitude angle Θ and an azimuth angle Φ. The object lens assembly is generally configured to focus the beam to an area at the object focal plane through at least (a) a 15° range of altitude angles and (b) a 90° range of azimuth angles simultaneously. For example, the incidence angles can be simultaneously focused through altitude angles Θ of 0° to at least 45°, and more preferably from 0° to greater than 70° (e.g., 0° to 88°), and azimuth angles Φ of 0° to greater than approximately 90° (e.g., 0° to 360°). As a result, the object lens assembly 300 can form a conical beam having a large range of incidence angles (Θ,Φ) to capture a significant amount of data in a single measurement of the workpiece W. This is expected to enhance the utility and throughput of scatterometry for determining overlay alignment error in real time and in-situ on a process tool.

In several embodiments, the relationship between the altitude angle Θ and the point on the second focal plane 340 through which a ray of the convergent beam 310 passes can be represented by a sine relationship. In one embodiment, the relationship can be represented by the following equation:

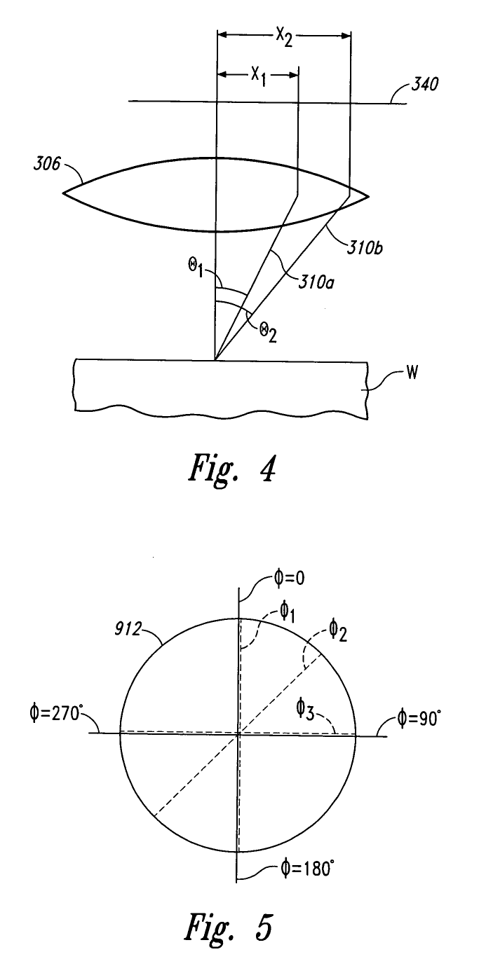

X=F sin Θ

in which
F=a constant;
X=the distance from the center of the second focal plane 340; and
Θ=the altitude angle.
   For example, FIG. 4 is a schematic diagram illustrating a convergent beam 310 having a first ray 310a with a first altitude angle Θ₁ and a second ray 310b with a second altitude angle Θ₂. The first ray 310a passes through the second focal plane 340 at a distance X₁ or F sin Θ₁ from the center of the focal plane 340, and the second ray 310b passes through the second focal plane 340 at a distance X₂ or F sin Θ₂ from the center of the focal plane 340. The relationship between the distance X and the altitude angle Θ creates a linear relationship between the pixels on the image sensor and the altitude angles Θ.

Referring back to FIG. 2A, the second optics assembly 240 includes a relay lens 242, an output beam splitter 244, and an image-forming lens 246. The relay lens 242 and the output beam splitter 244 present the reflected and/or diffracted radiation (i.e., return radiation) from the beam splitter 230 to the image-forming lens 246, and the image-forming lens 246 “maps” the angular distribution of reflectance and/or diffraction (i.e., the radiation distribution) from the second focal plane 340 to the imaging array of the detector 400. In a particular embodiment, the image-forming lens 246 preferably presents the image to the detector 400 such that the pixels of the imager in the detector 400 can be mapped to corresponding areas in the second focal plane 340.

The second optics assembly 240 can further include a polarizing beam splitter 248 to separate the return radiation into the p- and s-polarized components. In one embodiment, the polarizing beam splitter 248 is positioned between the output beam splitter 244 and the image-forming lens 246. In another embodiment, the beam splitter 248 is positioned at a conjugate of the focal spot on the wafer along a path between the image-forming lens 246 and the detector 400 (shown in dashed lines). In still another embodiment, the polarizing beam splitter 248 can be located between the relay lens 242 and the output beam splitter 244 (shown in dotted lines). The polarizing beam splitter 248 is generally located to maintain or improve the spatial resolution of the original image of the focal spot on the workpiece. The location of the polarizing beam splitter 248 can also be selected to minimize the alteration to the original optical path. It is expected that the locations along the optical path between the relay lens 242 and the image-forming lens 246 will be the desired locations for the polarizing beam splitter 248.

The polarizing beam splitter 248 provides the separate p- and s-polarized components of the return radiation to improve the calibration of the scatterometer 10 and/or provide additional data for evaluating overlay alignment on the workpiece W. For example, because the optics may perturb the polarization of the input and output radiation, the polarizing beam splitter 248 provides the individual p- and s-polarized components over the large range of incidence angles. The individual p- and s-polarized components obtained in this system can accordingly be used to calibrate the scatterometer 10 to compensate for such perturbations caused by the optical elements. Additionally, the p- and s-polarized components can be used for obtaining additional data that can enhance the precision and accuracy of processing the data.

FIG. 2B is a schematic view of a cube-type polarizing beam splitter 248 for use in the scatterometer 10 shown in FIG. 2A. The cube-type polarizing beam splitter 248 receives a return radiation beam 249 and splits it into a p-polarized component beam 249a and an s-polarized component beam 249b. The cube-type polarizing beam splitter 248 can be a crystal with birefringence properties, such as calcite, KDP or quartz. The p- and s-polarized component beams 249a-b exit from the cube-type polarizing beam splitter 248 along at least substantially parallel paths. The p- and s-polarized beams 249a and 249b are also spaced apart from each other such that they form separate images on the detector 400. To increase the distance between the p- and s-polarized component beams 249a-b, the size of the polarizing beam splitter 248 can be increased. For example, as shown in dashed lines in FIG. 2B, a larger polarizing beam splitter 248 results in at least substantially parallel p- and s-polarized component beams 249a-b that are spaced apart from each another by a larger distance than the polarizing beam splitter 248 shown in solid lines 248. However, large cube-type polarizing beam splitters can alter the p- and s-polarized beams, and thus the size of polarizing beam splitter 248 is generally limited. As with the non-polarized return radiation, the individual p- and s-polarized component beams 249a-b impinge upon pixels of the detector 400 in a manner that they can be mapped to corresponding areas in the second focal plane 340 shown in FIG. 2A.

One advantage of several embodiments of scatterometers including cube-type polarizing beam splitters is that they provide fast, high-precision measurements of the p-and s-polarized components with good accuracy. The system illustrated in FIGS. 2A-B uses a single camera in the detector 400 to simultaneously measure both of the p- and s-polarized components of the return radiation 249. This system eliminates the problems of properly calibrating two separate cameras and registering the images from two separate cameras to process the data from the p- and s-polarized components. This system also eliminates the problems associated with serially polarizing the return radiation beam using a mechanically operated device because the polarizing beam splitter 248 can be fixed relative to the return beam 249 and the detector 400.

### D. Embodiments of Detectors

The detector 400 can have several different embodiments depending upon the particular application. In general, the detector is a two-dimensional array of sensors, such as a CCD array, a CMOS imager array, or another suitable type of “camera” or energy sensor that can measure the intensity, color or other property of the scattered radiation from the workpiece W corresponding to the distribution at the second focal plane 340. The detector 400 is preferably a CMOS imager because it is possible to read data from only selected pixels with high repeatability instead of having to read data from an entire frame. This enables localized or selected data reading, which is expected to (a) reduce the amount of data that needs to be processed and (b) eliminate data that does not have a meaningful contrast. Additional aspects of using CMOS images for image processing are described in more detail below. The p- or s-polarized components can be measured with a single CMOS imager to determine certain characteristics that are otherwise undetectable from non-polarized light. As such, using a CMOS imager and polarizing the reflected radiation can optimize the response to increase the resolution and accuracy of the scatterometer 10.

FIG. 2C is a schematic view showing a CMOS imager assembly for use in the detector 400 in accordance with an embodiment of the invention. In this example, the CMOS imager assembly includes a die 410 having an image sensor 412, focal optics 420, and packaging 430 defining an enclosed compartment 432 between the die 410 and the focal optics 420. The focal optics 420 typically have curved surfaces or other configurations such that they are not merely a plate having parallel, flat surfaces. Additionally, the CMOS imager assembly does not have a glass cover or other optical member with parallel, flat surfaces between the image sensor 412 and the focal optics 420. As such, the CMOS imager assembly illustrated in FIG. 2C does not have any flat optics in the compartment 432 between the image sensor 412 and the focal optics 420. In this embodiment, the polarizing beam splitter 248 is just upstream of the CMOS imager assembly 400 relative to the return radiation beam 249.

The CMOS imager assembly 400 illustrated in FIG. 2C is expected to provide several advantages for use in scatterometers. In several embodiments, for example, the lack of a cover or other flat optical member between the image sensor 412 and the focal optics 420 is expected to reduce perturbations in the return radiation beam 249 at the image sensor 412. More specifically, a glass member with parallel, flat surfaces between the focal optics 420 and the image sensor 412 can alter the return radiation just before it reaches the image sensor 412. By eliminating such glass members with parallel, flat surfaces, the CMOS imager assembly illustrated in FIG. 2C is expected to eliminate distortion or interference caused by a glass member with parallel surfaces.

### E. Computational Analyses

The computer 800 can use several different processes for evaluating the overlay offset of different layers on the workpiece W. In general, the computer 800 can determine the overlay offset angle by analyzing the measured radiation distribution based on the inventor's discovery that slices of the measured radiation have a generally symmetric intensity distribution at (a) the overlay offset angle, and (b) a second angle equal to the overlay offset angle plus 180 degrees. Because one cannot determine whether a particular angle corresponds to the overlay offset angle or the second angle based on the symmetrical intensity distribution of a slice of the measured radiation distribution, the term “offset angle” as used in this section refers to the overlay offset angle and/or the second angle. Or put another way, the offset angle refers to the angle at which one of the alignment structures is offset from the other alignment structure.

FIG. 5 is a schematic illustration of the outline of a detected radiation distribution image 912 based on the overlay error illustrated in FIG. 3, in which the first and second layers are offset in the X direction but not the Y direction. The computer 800 analyzes diametric slices of the image 912 taken at specific angles Φ to identify a slice with a symmetric intensity distribution. For purposes of brevity in this section, unless otherwise noted, a diametric slice of an image taken at a particular angle Φ=X° includes (a) a first radial slice taken at the angle Φ=X° and (b) a second radial slice taken at the angle Φ=X+180°. In several embodiments, the computer 800 can analyze a diametric slice at each degree of the image 912 between Φ=0 and Φ=180. In other embodiments, the computer 800 can evaluate a diametric slice at each fraction of a degree of the image 912 (e.g., each half of a degree) or a specific multiple of a degree of the image 912 (e.g., every three degrees) between Φ=0 and Φ=180. In additional embodiments, the computer 800 can evaluate a different range of angles on the image 912. In either case, the computer 800 determines the offset angle of the alignment structures based on the angle Φ of the diametric slice with a generally symmetrical intensity distribution. In other embodiments, the evaluation of the diametric slices can be performed manually to identify the slice with the greatest symmetry.

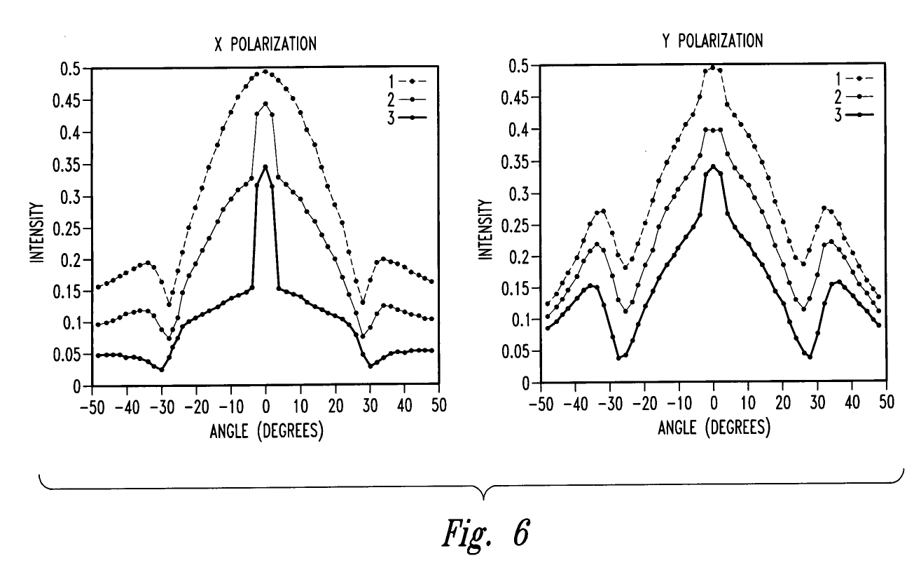

FIGS. 6-8 schematically illustrate several examples of intensity distributions of particular diametric slices of the image 912. In FIGS. 6-11, the titles X Polarization and Y Polarization refer to polarization states such that for phi=0 and phi=90 degrees the polarization states are S and P, respectively. For example, FIG. 6 schematically illustrates the intensity distribution of a diametric slice of the image 912 taken at the angle Φ₁=0. In this particular embodiment, the data is based on a beam having wavelength of 632.8 nm and a range of altitude angle Θ between −48° and +48°. As noted above, the altitude angles Θ correspond to specific linear points on the image 912. Line 1 illustrates the expected intensity distribution of the image 912 if the first and second alignment structures M₁ and M₂ were aligned in the X direction (which they are not in FIG. 3) as well as the Y direction. Line 2 illustrates the expected intensity distribution of the image 912 with the first and second alignment structures M₁ and M₂ offset only in the X direction (i.e., Φ=0) as illustrated in FIG. 3. Line 3 illustrates the expected intensity distribution of the image 912 with the first and second alignment structures M₁ and M₂ offset only in the X direction (i.e., Φ=0) by a distance greater than that shown in FIG. 3. As illustrated by lines 2 and 3, the measured intensity distribution along the diametric slice at Φ₁=0 is symmetrical about the altitude angle Θ=0, and the symmetry is not affected by the offset distance. Therefore, if the offset angle of the first and second alignment structures M₁ and M₂ were unknown, one could determine that the first and second alignment structures M₁ and M₂ are offset only in the X direction (i.e., Φ=0) because the diametric slice at Φ₁=0 is symmetrical.

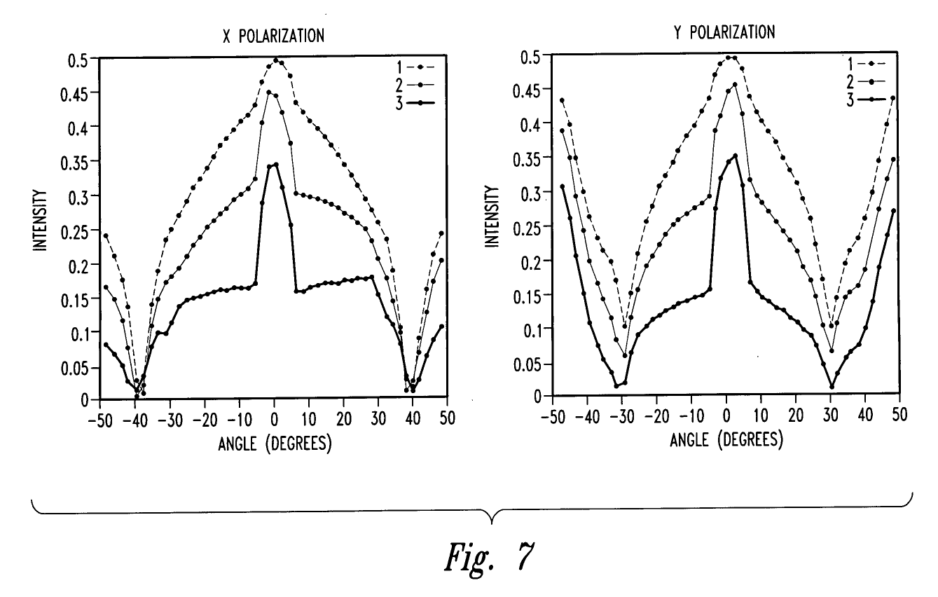

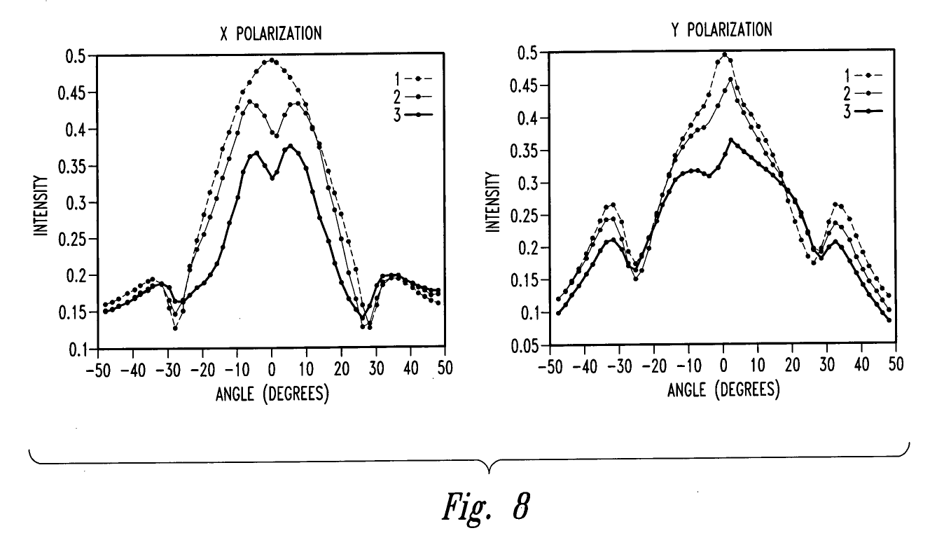

FIGS. 7 and 8 schematically illustrate intensity distributions of diametric slices of the image 912 taken at angles Φ₂=45 and Φ₃=90, respectively. In both FIGS. 7 and 8, line 1 illustrates the expected intensity distribution of the image 912 if the first and second alignment structures M₁ and M₂ were aligned in the both the X and Y directions (which they are not in FIG. 3); line 2 illustrates the expected intensity distribution of the image 912 with the first and second alignment structures M₁ and M₂ offset only in the X direction (i.e., Φ=0) as illustrated in FIG. 3; and line 3 illustrates the expected intensity distribution of the image 912 with the first and second alignment structures M₁ and M₂ offset only in the X direction (i.e., Φ=0) by a distance greater than that shown in FIG. 3. Referring only to FIG. 7, line 2 is asymmetrical about the altitude angle Θ=0. Accordingly, if the offset angle of the first and second alignment structures M₁ and M₂ were unknown, one could determine that the first and second alignment structures M₁ and M₂ are not offset equally in the X and Y directions (i.e., Φ=45) because the intensity distribution of the diametric slice at Φ₂=45 is asymmetrical. Similarly, referring only to FIG. 8, line 3 is asymmetrical about the altitude angle Θ=0. Accordingly, if the offset angle of the first and second alignment structures M₁ and M₂ were unknown, one could determine that the first and second alignment structures M₁ and M₂ are not offset only in the Y direction (i.e., Φ=90) because the intensity distribution of the diametric slice at Φ₃=90 is asymmetrical.

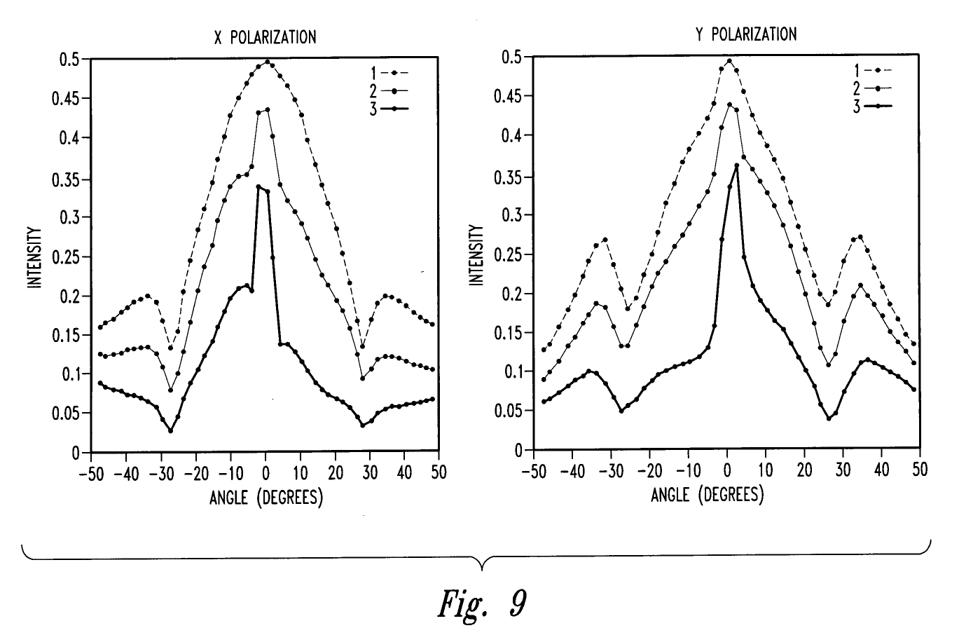

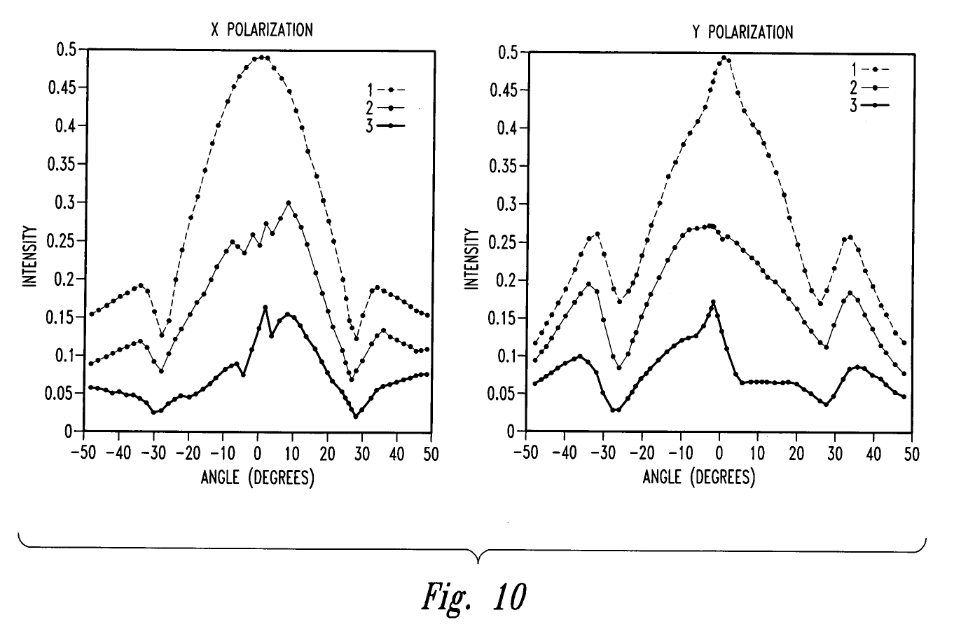

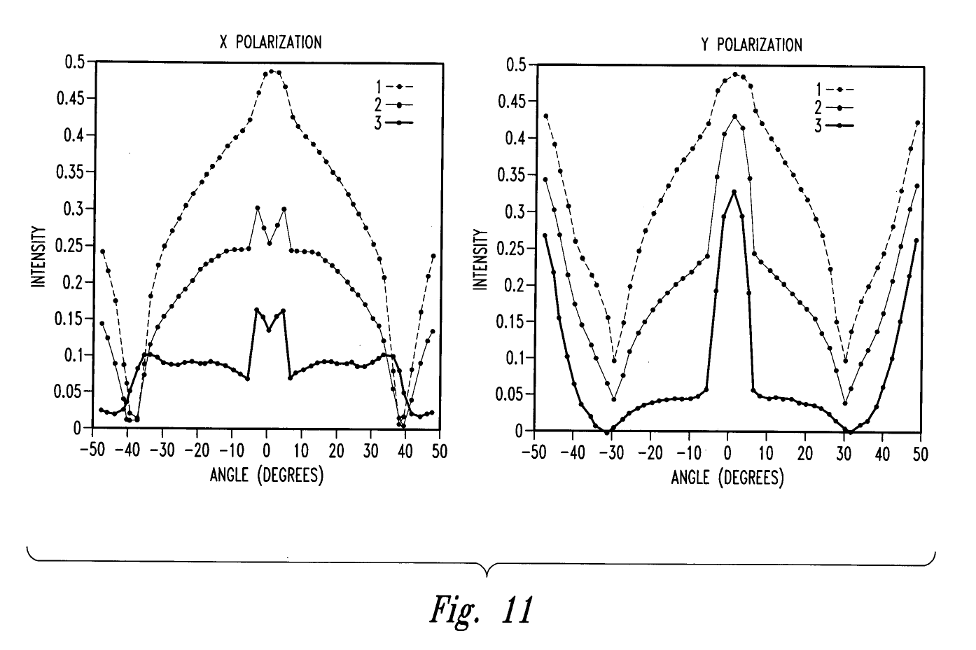

FIGS. 9-11 schematically illustrate additional examples of intensity distributions of particular diametric slices resulting from misaligned alignment structures. For example, line 2 in FIG. 9 illustrates the intensity distribution of a diametric slice of an image (not shown) taken at the angle Φ=0. Because the intensity distribution is asymmetrical about the altitude angle Θ=0, one can determine that the first and second alignment structures are not offset along the angle Φ=0°. Line 2 in FIG. 10 illustrates the intensity distribution of a diametric slice of the image taken at the angle Φ=90. Because the intensity distribution is asymmetrical about the altitude angle Θ=0, one can determine that the first and second alignment structures are not offset along the angle Φ=90°. Line 2 in FIG. 11 illustrates the intensity distribution of a diametric slice of the image taken at the angle Φ=45. Because the intensity distribution is symmetrical about the altitude angle Θ=0, the first and second alignment structures are offset along the angle Φ=45°. As noted above, because the intensity distribution is symmetrical about (a) the overlay offset angle, and (b) a second angle equal to the overlay offset angle plus 180 degrees, it is unclear whether the second alignment structure is offset at an angle of 45° or 225° relative to the first alignment structure. However, it is clear that one alignment structure is offset at an angle of 45° relative to the other alignment structure.

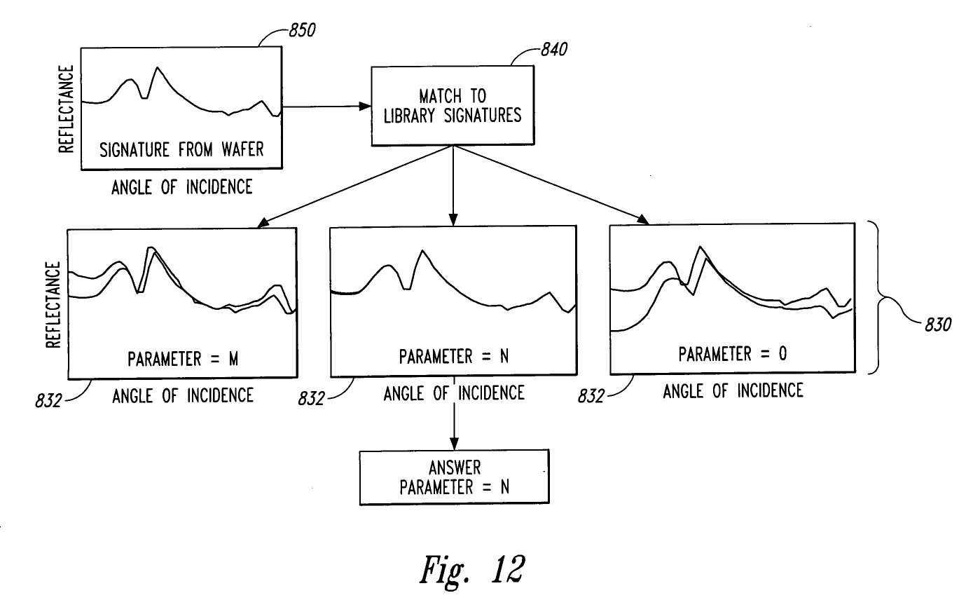

The measured radiation distribution can therefore be used to determine the offset angle of the first and second layers of a workpiece. After calculating the offset angle, the computer 800 can use the offset angle as a fixed input to determine the offset distance and direction. For example, FIG. 12 illustrates one embodiment for ascertaining other overlay offset parameters. In this embodiment, the computer 800 includes a database 830 including a large number of predetermined simulated reference radiation distributions 832 corresponding to different sets of alignment structure parameters. The computer 800 further includes a computer-operable medium 840 that contains instructions that cause the computer 800 to select a simulated radiation distribution 832 from the database 830 that adequately fits a measured radiation distribution within a desired tolerance and has the calculated offset angle. The computer-operable medium 840 can be software and/or hardware that evaluates the fit between the stored simulated radiation distributions 832 and the measured radiation distribution in a manner that quickly selects the simulated radiation distribution 832 having the best fit with the measured radiation distribution or at least having an adequate fit within a predetermined tolerance. In the case where a plurality of the simulated radiation distributions 832 have an adequate fit with the measured radiation distribution, the computer 800 can extrapolate or interpolate between the simulated distributions. Once the computer has selected a simulated radiation distribution with an adequate fit or the best fit, the computer selects the alignment structure parameters associated with the selected simulated distribution.

In an alternative embodiment, the computer 800 calculates a simulated radiation distribution and performs a regression optimization to best fit the measured radiation distribution with the simulated radiation distribution in real time. Although such regressions are widely used, they are time consuming and they may not reach a desired result because the regression may not converge to within a desired tolerance.

One feature of the scatterometer 10 described above is that the computer 800 can determine the angle of the overlay error by analyzing the measured radiation distribution. An advantage of this feature is that calculating the angle of overlay error reduces the number of unknown overlay parameters and the subsequent processing required to solve for those variables. This is expected to increase the accuracy of overlay error measurements and improve the precision of the process. Reducing the subsequent processing required to calculate other unknown overlay parameters is expected to increase the throughput of the fabrication process.

Another feature of the scatterometer 10 described above is that the scatterometer 10 can determine the overlay error parameters with doubly periodic alignment structures. An advantage of this feature is that doubly periodic alignment structures have smaller footprints than many conventional targets and therefore can be formed in many locations on the workpiece that would otherwise be unavailable. Another advantage of this feature is that the scatterometer 10 can determine the overlay error parameters with only a single measurement. This is expected to reduce the time required to calculate overlay error and increase throughput.

From the foregoing, it will be appreciated that specific embodiments of the invention have been described herein for purposes of illustration, but that various modifications may be made without deviating from the invention. Furthermore, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

I claim:

1. A method of assessing overlay error on a workpiece, the method comprising:
generating a beam having a wavelength;
irradiating a first alignment structure on a first layer of a workpiece and a second alignment structure on a second layer of the workpiece by passing the beam through an object lens assembly that focuses the beam to a focus area at a focal plane, wherein the beam is simultaneously focused through angles of incidence having (a) altitude angles of 0° to at least 15° and (b) azimuth angles of 0° to at least 90°;
detecting an actual radiation distribution corresponding to radiation scattered from the first and second alignment structures; and
estimating an offset parameter of the first and second alignment structures based on the detected radiation distribution.

2. The method of claim 1 wherein estimating the offset parameter of the first and second alignment structures comprises:
determining an intensity distribution along a plurality of sections of the detected radiation distribution; and
identifying a particular section with a generally symmetrical intensity distribution.

3. The method of claim 1 wherein estimating the offset parameter of the first and second alignment structures comprises:
calculating an intensity distribution along a plurality of diametric lines of the detected radiation distribution;
selecting one of the diametric lines with a generally symmetrical intensity distribution; and
determining an angle of the selected line.

4. The method of claim 1 wherein estimating the offset parameter of the first and second alignment structures comprises identifying a particular section of the detected radiation distribution with a generally symmetrical intensity distribution.

5. The method of claim 1 wherein estimating the offset parameter of the first and second alignment structures comprises determining an offset angle of the first and second alignment structures.

6. The method of claim 1 wherein irradiating the first and second alignment structures comprises irradiating a doubly periodic first alignment structure and a doubly periodic second alignment structure.

7. The method of claim 1 wherein:
the object lens assembly is configured to maintain a sine relationship between the altitude angles and corresponding points on the detected radiation distribution;
the sine relationship is represented by the following formula: X=F sin Θ;
F is a constant;
X is a displacement in the detected radiation distribution; and
Θ is the altitude angle.

8. The method of claim 1, further comprising:
providing a database having a plurality of simulated intensity distributions corresponding to different sets of alignment structure parameters; and
identifying a simulated intensity distribution that adequately fits the representation of the detected intensity distribution and corresponds to the estimated offset parameter.

9. The method of claim 1 wherein irradiating the first and second alignment structures comprises irradiating a single first alignment member on the first layer and a single second alignment member on the second layer.

10. A method of evaluating overlay error on a workpiece, the method comprising:
providing a workpiece having a first doubly periodic alignment structure on a first layer of the workpiece and a second doubly periodic alignment structure on a second layer of the workpiece;
generating a beam of radiation having a wavelength;
passing the beam through a lens that focuses the beam to a focus area at a focal plane, wherein the focus area has a dimension not greater than 40 μm, and wherein the beam is focused through a range of angles of incidence having simultaneously (a) altitude angles of 0° to at least 15° and (b) azimuth angles of 0° to at least 90°;
detecting a radiation distribution of radiation returned from the first and second alignment structures; and
determining an offset angle of the first and second alignment structures based on the detected radiation distribution.

11. The method of claim 10 wherein determining the offset angle of the first and second alignment structures comprises:
determining an intensity distribution along a plurality of sections of the detected radiation distribution; and
identifying a particular section with a generally symmetrical intensity distribution.

12. The method of claim 10 wherein determining the offset angle of the first and second alignment structures comprises:
calculating an intensity distribution along a plurality of diametric lines of the detected radiation distribution;
selecting one of the diametric lines with a generally symmetrical intensity distribution; and
determining a position of the selected line.

13. The method of claim 10 wherein determining the offset angle of the first and second alignment structures comprises identifying a particular section of the detected radiation distribution with a generally symmetrical intensity distribution.

14. The method of claim 10, further comprising:
providing a database having a plurality of simulated intensity distributions corresponding to different sets of alignment structure parameters; and
identifying a simulated intensity distribution that adequately fits the representation of the detected intensity distribution and corresponds to the determined offset angle.

15. The method of claim 10 wherein passing the beam through the lens comprises irradiating a single first doubly periodic alignment member on the first layer and a single second doubly periodic alignment member on the second layer.

16. A method of evaluating overlay error on a workpiece, the method comprising:
providing a workpiece having a first alignment structure on a first layer of the workpiece and a second alignment structure on a second layer of the workpiece;
generating a beam of radiation having a wavelength;
irradiating the first and second alignment structures by passing the beam through a lens that focuses the beam to a focus area at a focal plane, wherein the beam is focused through a range of angles of incidence having simultaneously (a) altitude angles of 0° to at least 15° and (b) azimuth angles of 0° to at least 90°;
sensing a radiation distribution of radiation returned from the first and second alignment structures;
determining an intensity distribution along a plurality of sections of the sensed radiation distribution;
identifying a particular section with the greatest symmetry; and
calculating an offset angle of the first and second alignment structures based on a position of the section with the greatest symmetry.

17. The method of claim 16 wherein calculating the offset angle of the first and second alignment structures comprises determining the offset angle based on an angle of the section with the greatest symmetry.

18. The method of claim 16 wherein:
determining the intensity distribution along the sections comprises calculating the intensity distribution along a plurality of diametric lines of the sensed radiation distribution;
identifying the particular section with the greatest symmetry comprises selecting one of the diametric lines with a generally symmetrical intensity distribution; and
calculating the offset angle of the first and second alignment structures comprises determining an angle of the selected line.

19. The method of claim 16 wherein irradiating the first and second alignment structures comprises irradiating a first doubly periodic alignment member on the first layer and a second doubly periodic alignment member on the second layer.

20. A scatterometer for evaluating overlay error on a workpiece, the workpiece including a first alignment target on a first layer and a second alignment target on a second layer, the scatterometer comprising:
an irradiation source for producing a beam of radiation along a path;
an optic member aligned with the path of the beam, the optic member being configured to condition the beam;
an object lens assembly aligned with the path of the beam and positioned between the optic member and a workpiece site, the object lens assembly being configured to (a) receive the conditioned beam, (b) simultaneously focus the conditioned beam through a plurality of altitude angles to a spot at an object focal plane, (c) receive return radiation in the wavelength scattered from the workpiece, and (d) present a radiation distribution of the return radiation at a second focal plane;
a detector positioned to receive the radiation distribution and configured to produce a representation of the radiation distribution; and
a controller operably coupled to the detector, the controller having a computer-readable medium containing instructions to calculate an offset angle between the first and second alignment targets of the workpiece based on the representation of the radiation distribution.

21. The scatterometer of claim 20 wherein the computer-readable medium has instructions to perform a method comprising:
irradiating the first and second alignment targets with the beam;
detecting the radiation distribution;
determining an intensity distribution along a plurality of sections of the detected radiation distribution; and
identifying a particular section with a generally symmetrical intensity distribution.

22. The scatterometer of claim 20 wherein the computer-readable medium has instructions to perform a method comprising:
irradiating the first and second alignment targets with the beam;
detecting the radiation distribution;
calculating an intensity distribution along a plurality of diametric lines of the detected radiation distribution;
selecting one of the diametric lines with a generally symmetrical intensity distribution; and
determining an angle of the selected line.

23. The scatterometer of claim 20 wherein the computer-readable medium has instructions to perform a method comprising identifying a particular section of the representation of the radiation distribution with a generally symmetrical intensity distribution.

24. The scatterometer of claim 20 wherein:
the object lens assembly is configured to maintain a sine relationship between the altitude angles and corresponding points on the received radiation distribution;
the sine relationship is represented by the following formula: X=F sin Θ;
F is a constant;
X is a displacement in the received radiation distribution; and
Θ is the altitude angle.

25. The scatterometer of claim 20 wherein:
the computer-readable medium includes a database having a plurality of simulated radiation distributions corresponding to different sets of alignment target parameters; and
the computer-readable medium has instructions to perform a method comprising identifying a simulated intensity distribution that adequately fits the representation of the received intensity distribution and corresponds to the offset angle.

26. The scatterometer of claim 20 wherein the irradiation source comprises a laser configured to produce a beam having a wavelength of between approximately 200 nm and approximately 475 nm.

27. The scatterometer of claim 20 wherein the object lens assembly is configured to focus the conditioned beam to a spot size not greater than 40 μm.

28. The scatterometer of claim 20 wherein the object lens assembly is further configured to simultaneously focus the conditioned beam at the object focal plane through at least (a) a 15° range of altitude angles and (b) a 90° range of azimuth angles.

29. A scatterometer for evaluating overlay error on a workpiece, the workpiece including a first alignment structure on a first layer and a second alignment structure on a second layer, the scatterometer comprising:
a radiation source configured to produce a beam of radiation having a wavelength;
an optical system having a first optics assembly and an object lens assembly, wherein the first optics assembly is configured to condition the beam of radiation such that beam is diffuse and randomized, and wherein the object lens assembly is configured to (a) focus the beam at an area of an object focal plane and (b) present a radiation distribution of return radiation scattered from an alignment structure in a second focal plane;
a detector positioned to receive the radiation distribution and configured to produce a representation of the radiation distribution; and
a controller operably coupled to the radiation source and detector, the controller including a computer-readable medium containing instructions to perform a method comprising-
irradiating the first and second alignment structures;
detecting the radiation distribution; and
estimating an offset parameter of the first and second alignment structures based on the detected radiation distribution.

30. The scatterometer of claim 29 wherein the instructions to estimate the offset parameter comprise instructions to (a) determine an intensity distribution along a plurality of sections of the detected radiation distribution, and (b) identify a particular section with a generally symmetrical intensity distribution.

31. The scatterometer of claim 29 wherein the instructions to estimate the offset parameter comprise instructions to (a) calculate an intensity distribution along a plurality of diametric lines of the detected radiation distribution, (b) select one of the diametric lines with a generally symmetrical intensity distribution, and (c) determine an angle of the selected line.

32. The scatterometer of claim 29 wherein the instructions to estimate the offset parameter comprise instructions to calculate an offset angle between the first and second alignment structures of the workpiece.

33. The scatterometer of claim 29 wherein:
the computer-readable medium includes a database having a plurality of simulated radiation distributions corresponding to different sets of alignment structure parameters; and
the computer-readable medium has instructions to perform a method comprising identifying a simulated intensity distribution that adequately fits the representation of the detected intensity distribution and corresponds to the offset parameter.
